(19) United States
(12) Patent Application Publication
(10) Pub. No.: US 2025/0259088 A1
(43) Pub. Date: Aug. 14, 2025

(54) Observer Collapse Control Systems for Quantum Memory, Biofeedback, and AI-Guided Interference Applications

(71) Applicant: Larry Lim Kheng Cheong, Singapore (SG)

(72) Inventor: Larry Lim Kheng Cheong, Singapore (SG)

(21) Appl. No.: 19/181,360

(22) Filed: Apr. 17, 2025

(51) Int. Cl. G06N 10/20; G06N 10/60

(52) U.S. Cl. CPC G06N 10/20; G06N 10/60

(57) ABSTRACT

This invention presents a systems-level application of observer-induced collapse theory, enabling targeted localization of quantum states using engineered observer wavefunctions across three domains: quantum memory control, biological feedback systems, and AI-guided collapse operations. Building upon the Modified Schrödinger Equation (MSE), collapse is modeled as a curvature-driven localization event initiated by dynamic convergence between an external observer wave Ψₒ(t) and the system wavefunction Ψₚ(t), satisfying Ψₚ ′(t)>δ. The invention implements this principle through three interlinked models: (1) quantum memory write/read collapse, (2) biological signal-induced collapse for diagnostics or feedback devices, and (3) AI-generated observer waves for active system control and optimization. Each framework supports both physical and algorithmic implementation, including analog interference sources, neural feedback circuits, and reinforcement-trained models. This Continuation-in-Part introduces observer-controlled wave collapse as a functional mechanism for quantum information storage, medically responsive systems, and decision-optimized AI systems, offering a unified framework for engineered collapse in probabilistic environments.

### 1. FIELD OF THE INVENTION

The present invention pertains to quantum control systems, information processing, and neuro-interactive technologies. More specifically, it relates to physical and computational methods for directing wavefunction collapse in quantum, biological, and artificial intelligence systems through engineered observer wave interference. This invention extends collapse theory from a theoretical construct to a practical mechanism for storage, feedback, sensing, and adaptive prediction in real-world systems.

### 2. BACKGROUND OF THE INVENTION

Traditional interpretations of wavefunction collapse treat it as an instantaneous, observer-triggered transition from superposition to a single measurable state, but offer no physical description of the collapse mechanism. The Copenhagen interpretation frames measurement as epistemic, while the Many-Worlds interpretation removes collapse entirely, relying on branching universes. These frameworks have been insufficient in providing tools for engineered, predictive collapse in physical or computational systems.

Recent advances in observer-induced collapse theory (see Utility application Ser. No. 19/172,805 and CIP2 No. 19/178,991) introduce a causal model wherein the collapse of the wavefunction Ψₚ(t) is triggered by the interference pattern created through interaction with an external observer wavefunction Ψₒ(t). Collapse occurs when the second time derivative of the system's integrated probability density—Ψₚ ′(t)—exceeds a critical curvature threshold δ. This approach offers a physically realizable model of wavefunction collapse as a result of convergence-induced localization.

This invention builds upon that foundation to create operational control systems where collapse is no longer merely observed but actively directed—using engineered waveforms, biofeedback signals, or machine-generated patterns. The invention thus bridges quantum physics, biotechnology, and machine intelligence through a unified collapse activation model, enabling deterministic control over probabilistic outcomes.

### 3. SUMMARY OF THE INVENTION

The present invention introduces three integrated collapse control models that operationalize wavefunction localization in applied domains by leveraging convergence between observer wavefunctions Ψₒ(t) and system wavefunctions Ψₚ(t). Each model adheres to a unified physical criterion: collapse occurs when the second time derivative of the integrated probability density, Ψₚ ′(t), exceeds a critical curvature threshold δ. This threshold is physically realized via engineered interference between Ψₒ(t) and Ψₚ(t), enabling deterministic, tunable collapse.

The invention is comprised of the following subsystems:

### (1) Quantum Memory Collapse Control (QMC)

This subsystem implements collapse-based memory encoding by synchronizing a controlled observer waveform Ψₒ(t) with a selected memory-state wavefunction Ψₚₖ(t). Memory writing occurs when Ψₒ(t) is phase-locked and amplitude-aligned with Ψₚₖ(t), triggering Ψₚ′(t)>δ and collapsing the superposition into a definite state. Readout mechanisms may function via repeatable convergence or reversibly engineered feedback Ψₒ⁻(t). Quantum memory operations here are not stochastic but engineered via collapse-localization at selected storage branches.

Use cases include:
Collapse-based quantum RAM/ROM systems
Secure, convergence-encoded storage
Time-gated memory channels in quantum computing

### (2) Biofeedback-Induced Collapse Systems (BCT)

This subsystem employs real-time physiological signals—such as EEG, ECG, or skin conductance—as the source of Ψₒ(t). The invention integrates biological wave sources into collapse control systems where biologically generated Ψₒ(t) interacts with a target quantum or probabilistic system. Collapse occurs when alignment occurs naturally or via amplified convergence, transforming biofeedback into a localized selector of system states.

Applications include:
Neuro-quantum interfaces and diagnostics
Mind-triggered state switching in sensors or imaging
Collapse-activated therapeutic or measurement systems

This enables medical and neurotechnology systems to influence or observe collapse dynamics in real time.

### (3) AI-Guided Collapse Steering (AICS)

This subsystem utilizes deep learning and reinforcement models to generate observer wavefunctions Ψₒ(t) adaptively. These AI-generated Ψₒ(t) signals are trained to maximize convergence with desirable system paths (e.g., optimal economic or control outcomes) by forecasting and phase-aligning with Ψₚ(t) in real time. Collapse is not predicted—it is steered.

Possible implementations include:
Quantum decision engines
AI-driven collapse switches in cyber-physical systems
Real-time adaptive financial risk systems
Autonomous agent environments using probabilistic collapse resolution

This model merges learning-based prediction with physical control, enabling closed-loop quantum-classical systems.

### Unified Control Framework

All three systems rely on a shared physical mechanism:
1. Identify the system wavefunction Ψₚ(t)
2. Generate or detect observer wave Ψₒ(t)
3. Monitor Ψₚ′(t) dynamically
4. Trigger collapse when Ψₚ′(t)>δ

The invention thus provides a generalized collapse control framework across diverse hardware and software environments—treating collapse not as random, but as an engineerable convergence phenomenon.

### 4. Detailed Description of the Invention

The present invention is based on the principle that wavefunction collapse is not merely a probabilistic measurement outcome, but a physical localization event induced by wave convergence. When a system wavefunction Ψₚ(t, x) is exposed to an external wave Ψₒ(t, x), and the interaction produces a curvature spike in the system's probability evolution, collapse is initiated.

Collapse occurs under the following criterion:

$${Ψ}_{p}^{″} ( t ) = \frac{{d}^{2}}{d {t}^{2}} \int {\vert {Ψ}_{p} ( t , x ) \vert}^{2} d x > δ$$

where:
Ψₚ(t, x) is the system wavefunction,
Ψₒ(t, x) is the external observer wave,
Ψₚ′(t) is the second time derivative of the total probability amplitude (curvature),
δ is a system-specific threshold.

The invention manipulates Ψₒ(t) using three control modalities: memory-based signals, biological waveforms, and AI-generated feedback. Each implementation varies the source and structure of Ψₒ(t), but all share a convergence-based control mechanism.

### 1. Quantum Memory Collapse Control (QMC)

This model enables selective write/read operations by aligning Ψₒ(t) with a target branch Ψₚₖ(t) within a superposition. Each memory “state” corresponds to a component wavefunction in Ψₚ(t):

$${Ψ}_{p} ( t ) = {\sum }_{k} {α}_{k} {ψ}_{k} ( t )$$

An engineered Ψₒ(t) is applied to overlap constructively with one target state ψₖ(t):

$${C}_{k} ( t ) = \int {Ψ}_{o} ( t , x ) \cdot {ψ}_{k} ( t , x ) dx$$

When this overlap is strong enough to induce Ψₚ′(t)>δ, only the k^{th} path collapses—resulting in deterministic memory selection.

### Write Process:

A phase-controlled wave Ψₒ(t) is introduced to reinforce ψₖ(t)
Collapse is induced once Ψₚ′(t) exceeds δ
The state is stored in collapsed form

### Read Process:

A replica or conjugate Ψₒ⁻t) is introduced
Collapse reoccurs only if the original state is present

This mechanism enables convergence-locked storage and retrieval-fundamentally different from probabilistic quantum state observation.

### 2. Biofeedback Collapse Triggering (BCT)

Here, the observer wave Ψₒ(t) is sourced from physiological or environmental biological signals, such as:
EEG (brainwaves)
ECG (heart rhythms)
Skin conductance or muscular response
Microbiological oscillation patterns

The bio-signal Ψₒ(t) is:
Recorded, digitized, or fed into analog collapse circuits.
Phase-aligned or modulated to interact with a target system Ψₚ(t)
Amplified if needed via optical or acoustic transducers

Collapse triggers when:

$${Ψ}_{p}^{″} ( {t}_{b i o} ) = \frac{{d}^{2}}{d {t}^{2}} \int {\vert {Ψ}_{p} ( t , x ) \cdot {Ψ}_{o}^{b i o} ( t , x ) \vert}^{2} d x > δ$$

### Applications Include:

Collapse-based neurodiagnostics
Quantum neurointerfaces
Biological state readers

Collapse here becomes an interface between biological state and quantum selection—allowing bio-dynamic control of physical state outcomes.

### 3. AI-Guided Collapse Steering (AICS)

This model utilizes artificial intelligence, particularly:
Recurrent Neural Networks (RNNs)
Long Short-Term Memory (LSTM) models
Transformer architectures

These AI systems learn the system dynamics of Ψₚ(t), then generate optimal Ψₒ(t) waveforms to:
Maximize collapse on beneficial or goal-aligned states
Suppress collapse on noise or irrelevant paths

The generated observer wave Ψₒ(t) is learned via convergence optimization:

$${Ψ}_{o} ( t ) = arg {max}_{Ψ} ( \frac{{d}^{2}}{d {t}^{2}} \int {\vert Ψ ( t , x ) \cdot {Ψ}_{p} ( t , x ) \vert}^{2} d x )$$

### In Practice:

The AI system receives a continuous stream of system data
Predicts the evolution of Ψₚ(t)
Outputs Ψₒ(t) in real-time to steer collapse toward ideal outcomes

### Applications Include:

Quantum decision engines (e.g., finance, defense)
Cyber-physical quantum control systems
Collapse-optimized navigation or classification systems

This framework allows systems to learn how to collapse themselves, merging physical causality with algorithmic control.

### Physical and Digital Architecture

Each implementation may take the form of:
Pure software collapse engines (simulation only)
Physical systems using wave generators, electrodes, or sensors
Hybrid devices (e.g., neural implants, quantum memory chips, AI-driven interfaces)

The observer wave Ψₒ(t) may be:
Analog (RF, laser, acoustic)
Digital (simulated wave packet, algorithmic projection)
Biophysical (recorded signal transduced into wave-compatible form)

1. An engineered quantum memory system comprising:
a system wavefunction Ψₚ(t) representing a quantum memory register;
an observer wavefunction Ψₒ(t) aligned to overlap with a target memory state Ψₚₖ(t); and
a collapse trigger when the second time derivative of the integrated probability density, Ψₚ′(t), exceeds a threshold δ;
wherein the system causes deterministic collapse of Ψₚ(t) into the state Ψₚₖ(t) by observer interference, effecting quantum memory selection.

2. A quantum collapse control system comprising:
a machine learning subsystem trained to generate observer wavefunctions Ψₒ(t) from system feedback;
a probabilistic or quantum system characterized by Ψₚ(t); and
a controller configured to compare Ψₒ(t) and Ψₚ(t) to determine convergence strength;
wherein collapse is induced only when Ψₚ′(t) exceeds a threshold δ due to generated convergence, enabling real-time AI-guided outcome selection.

3. The system of claim 1, wherein Ψₒ(t) is generated by a phase-locked analog or digital wave generator.

4. The system of claim 1, wherein read and write operations are governed by pre-defined collapse time windows.

5. The system of claim 1, wherein Ψₒ(t) is engineered to match a memory path within a coherent superposition of memory states.

6. The system of claim 1, further comprising an error detection module to reverse or reinitiate collapse attempts.

7. The system of claim 2, wherein the machine learning subsystem comprises a recurrent neural network (RNN) or LSTM.

8. The system of claim 2, wherein the machine learning model is trained to maximize curvature Ψₚ′(t) during decision-critical moments.

9. The system of claim 2, wherein observer wave generation is updated dynamically in response to real-time system data.

10. A biologically modulated collapse system comprising:
a physiological signal source acting as Ψₒ(t), selected from EEG, ECG, GSR, or biofield input;
a quantum system defined by Ψₚ(t); and
a convergence monitor configured to detect when Ψₒ(t) interferes constructively with Ψₚ(t);
wherein collapse is triggered by biological signal alignment causing Ψₚ′(t)>δ.

11. The system of claim 10, wherein the biological signal is acquired through non-invasive electrodes or sensors.

12. The system of claim 10, wherein the bio-generated observer wave is amplified or modulated via an optical or electrical transducer.

13. The system of claim 10, wherein collapse events are recorded and correlated with physiological state indicators.

14. The system of claim 10, wherein multiple bio-sources are used in interference superposition to steer collapse in multi-agent environments.

15. A hybrid collapse framework comprising at least one of the systems in claims 1, 2, or 10, integrated with a feedback loop that modulates Ψₒ(t) based on prior collapse efficiency metrics.
